(19) United States
(12) Patent Application Publication
(10) Pub. No.: US 2026/0119974 A1
(43) Pub. Date: Apr. 30, 2026

(54) DEPLOYMENT OF ARTIFICIAL INTELLIGENCE-BASED SYSTEMS

(71) Applicant: Dell Products L.P., Round Rock, TX (US)

(72) Inventor: DHARMESH M. PATEL, Round Rock, TX (US)

(21) Appl. No.: 18/932,781

(22) Filed: Oct. 31, 2024

(51) Int. Cl. G06N 20/00

(52) U.S. Cl. CPC G06N 20/00

(57) ABSTRACT

Methods, systems, and devices are provided for managing operation of a system. To manage the system, supplemental capabilities may be identified and added to the system. The supplemental capabilities may be based on inferred changes in use of the system over time. The supplemental capabilities may be managed over time to meet changes in use of services provided by the system over time, while limiting excess capabilities of the system and meeting existing expectations regarding use of the system.

### FIELD

Embodiments disclosed herein relate generally to management of data processing systems. More particularly, embodiments disclosed herein relate to systems and methods for management of artificial intelligence-based systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating systems in accordance with an embodiment.

FIGS. 2A-2H show data flow diagrams illustrating data and processes for managing a system in accordance with an embodiment.

FIGS. 3A-3B show flow diagrams illustrating methods for managing operation of a system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems that may provide, at least in part, computer implemented services. The computer implemented services may be provided to any type and/or number of other devices and/or users of the data processing systems. Furthermore, the provided computer implemented services may be of any quantity and/or type of such services.

To provide the computer implemented services, data processing systems may include hardware components and/or software components. For example, operation of these components may facilitate various functionalities of a data processing system, thereby causing the data processing system to provide the computer implemented services. Additionally, such operation of the components may depend on how such components interact with one another and/or data each component may be adapted to use, for example, as specified by a system architecture in which these components may be a part.

For example, by changing how the components interact with one another, thereby changing the system architecture, the operation may be updated, and thus, may facilitate the various functionalities in a different (e.g., updated) manner and/or facilitate new functionalities all together than those prior to the update. Consequently, if the components are not configured to be in a correct architecture, then the services may not be provided as expected or desired by a consumer of such services.

To increase a likelihood of providing computer implemented services as expected and/or desired by a consumer of such services, a distributed system may be managed using subscriptions and may be over provisioned with supplemental capabilities beyond those expected to be necessary for the distributed system when deployed.

In an embodiment, a method for providing artificial intelligence services is provided. The method may include obtaining, by a management system, a non-actionable description of a goal for use of an artificial intelligence model in a workflow; inferring, by the management system, evolution of use of artificial intelligence services in the workflow over time; obtaining, by the management system and based on the evolution of the use, supplemental capabilities that exceed those necessary to facilitate use of the artificial intelligence model in the workflow as indicated by the non-actionable description; selecting, by the management system and based at least on the supplemental capabilities, hardware components and software components; obtaining, by the management system and based on the evolution of the use, a supplemental capabilities management plan for the hardware components and the software components; and providing, by the management system and via a managed system based on the hardware components and the software components, artificial intelligence services while limiting operation of the managed system based on the supplemental capabilities management plan.

The supplemental capabilities management plan may define limits on use of the hardware components and/or the software components over time.

The supplemental capabilities management plan may relax the limits of the use over time, and changes in the limits defined by the supplemental capabilities management plan are based on the evolution of the use of the artificial intelligence services in the workflow.

The method may also include obtaining the managed system; and deploying the managed system. The deploying may be performed prior to the providing of the artificial intelligence services.

The supplemental capabilities management plan may define at least one selected from a group of limits consisting of: derating of a hardware components of the hardware components from a nominal clock speed to a reduced clock speed; depowering of a processing core of the hardware component; and restricting workload types performable by the processing core.

The workload types may include at least selected from a list of workloads consisting of: inference model training; inferencing; and inference model updating.

The managed system may be adapted to enforce the restricting of the workload types performable by the processing core by limiting communication capabilities of the processing core.

The processing cores may be operably connected to a storage device via a communication bus, and bandwidth of the communication bus may be set by the managed system to enforce the restrictions of the workload types.

The processing core may be a core of a hardware accelerator (e.g., graphics processing unit, data processing unit, etc.).

The managed system may include at least one graphic processing unit that is in operable communication with a storage system via a communication bus.

In an embodiment, another method for providing artificial intelligence services is provided. The other method may include obtaining operation data for a managed system that provides the artificial intelligence services to a user; in an instance of the obtaining of the operation data where a limit of a subscription for the managed system has been reached: identifying a change in capability of the artificial intelligence services based on the subscription; selecting an update to be applied to at least one hardware component of the managed system based on the change in the capability and an architecture of an artificial intelligence system of hosted by the managed system that provides the artificial intelligence services; and enforcing the update on the at least one hardware component to obtain an updated managed system that provides different artificial intelligence services to the user.

The managed system may include at least one graphic processing unit that is in operable communication with a storage system via a communication bus. The enforcing of the update may include modifying a communication bandwidth of the communication bus.

The subscription may define: a time limit for one of a plurality of artificial intelligence workload types; and a rate for the one of the plurality of artificial intelligence workload types.

Selecting the update may include identifying a dependency of the one of the plurality of artificial intelligence workload types on the communication bus using the architecture; and selecting a new communication bandwidth for the communication bus to reduce the rate to a lower rate.

The plurality of artificial intelligence workload types may include inference model training having a first level of dependency on the communication bandwidth; inferencing having a second level of dependency on the communication bandwidth; and inference model updating having a third level of dependency on the communication bandwidth. The different levels may indicate that corresponding abilities to perform the respective workload types may vary based on the communication bandwidth.

Modifying the communication bandwidth may include modifying operation of a network that comprises the communication bus.

Enforcing the update may also include placing at least one core of the graphics processing unit into a locked in which the at least one core is unable to contribute to the different artificial intelligence services.

Enforcing the update may additionally include reconfiguring the artificial intelligence system to a default state in which the artificial intelligence services are unable to be provided to the user.

The operation data may include at least one selected from a group consisting of an inference count of inferences provided through the artificial intelligence services, a training count for trainings of models used in the artificial intelligence services, and an update count for updates of the models used in the artificial intelligence services.

The limit may be based on a rate of use of the artificial intelligence services or a count of use of the artificial intelligence services.

In an embodiment, a non-transitory media is provided. The non-transitory media may include instructions that when executed by a processor cause, at least in part, any of the methods discussed above to be performed.

In an embodiment, a data processing system is provided. The data processing system may include the non-transitory media and a processor and may, at least in part, perform any of the methods discussed above when the computer instructions are executed by the processor.

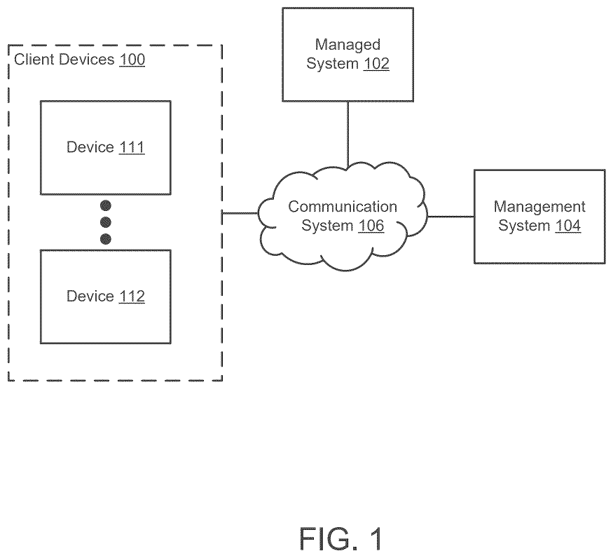

Turning to FIG. 1, a block diagram illustrating a system in accordance with an embodiment is shown. The system shown in FIG. 1 may be a distributed system that provides computer implemented services.

These services may include any type and/or quantity of services. These services may include, for example, database services, data processing services, electronic communication services, and/or any other services that may be provided by one or more computing devices. Other types of services may be provided by the system shown in FIG. 1 without departing from embodiments disclosed herein.

To provide these services, the system may include any number of data processing systems (e.g., computing devices) such as any of client devices 100. These data processing systems may include any quantity of software components and/or hardware components. These components may include, for example, processors, memory modules, storage devices, communications devices, power components, software applications, device drivers, and/or any other type of component whose respective operation may facilitate various functionalities of the data processing systems. By facilitating such functionalities of the data processing systems, the respective operation of such components may cause the services to be provided.

However, this operation of the hardware components and/or the software components may depend on an architecture of the components used during such operation. For example, the architecture of the components may determine which of the components may contribute to the operation, and how the contributing components may be configured to (i) interact with one another during the operation, and/or (ii) utilize various types and/or quantities of data. Consequently, if the components are not configured to be in a correct architecture, then the services may not be provided as expected or desired by a consumer of such services (e.g., correct services may not be provided as expected and/or desired by a service providing entity such as management system 104, discussed further below).

In general, embodiments disclosed herein relate to systems, devices, and methods for managing operation of a system that may provide computer implemented services. To manage the operation of the system, a combination of hardware components, software components, configurations, and/or other aspects regarding operation of a computing system (e.g., in aggregate a “system plan”) may be selected based on descriptions of desired uses of the system.

To improve the likelihood that a resulting system is able to meet both the desired uses (e.g., as described) and future uses, inferred use cases based on the descriptions may be established and used as a basis for selecting supplemental capabilities in addition to capabilities of an artificial intelligence architecture likely to meet the described desired uses. A management plan for the supplemental capabilities may be established for unlocking the supplemental capabilities over time, as the desired uses are likely to expand. Prior to being unlocked, use of the supplemental capabilities may be restricted.

Once the management plan is established, subscriptions for services provided by the system may be established. The subscriptions may define the services to be provided by the system and limits on the use of the provided services. To facilitate enforcement of the subscriptions, the architecture of an artificial intelligence system hosted by the system may be analyzed to identify how to limit use of the services (e.g., as opposed to complete prevention of use of the services). When subscription limits are reached, the operation of the system may be modified accordingly.

To provide the above noted functionality, the system of FIG. 1 may include client devices 100, managed system 102, management system 104, and communication system 106. Each of these is discussed below.

Client devices 100 may include any number of data processing systems such as devices 111 and 112. Any of these data processing systems may (i) use any number of the previously used AI models, for example, if previously managed by management system 104, (ii) provide computer implemented services, (iii) communicate with various systems, devices, and/or entities within the system of FIG. 1 (e.g., other devices of client devices 100, managed system 102, management system 104, and/or other devices not explicitly shown in FIG. 1) via, for example, operable connections that facilitate data transmissions, and/or (iv) cooperate with the various systems, devices, and/or entities (e.g., management system 104).

Managed system 102 may provide various services to client devices 100 (and/or other devices/entities). To do so, managed system may (i) include hardware and software components corresponding to desired services as indicated by the users of client devices 100, (ii) host a management framework usable by management system 104 to modify operation of managed system 102, (iii) enforce subscriptions established by management system 104, and/or perform other actions to facilitate provisioning of services desired by client devices 100 (and/or users thereof).

Management system 104 may manage operation of managed system 102 on behalf of users of client devices 100. To do so, management system 104 may (i) provide a portal or other interface through which users of client devices may indicate services that are to be provided by managed system 102 and establish limits to those services, (ii) select components of and facilitate deployment of managed system 102, (iii) modify the operation of managed system 102 over time (e.g., based on instructions from users of client devices 100 and/or other basis), and/or perform other actions to facilitate provisioning of services by managed system 102.

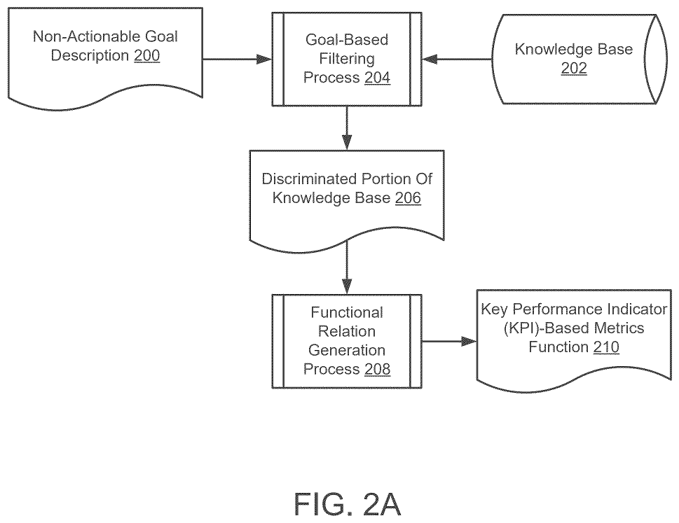

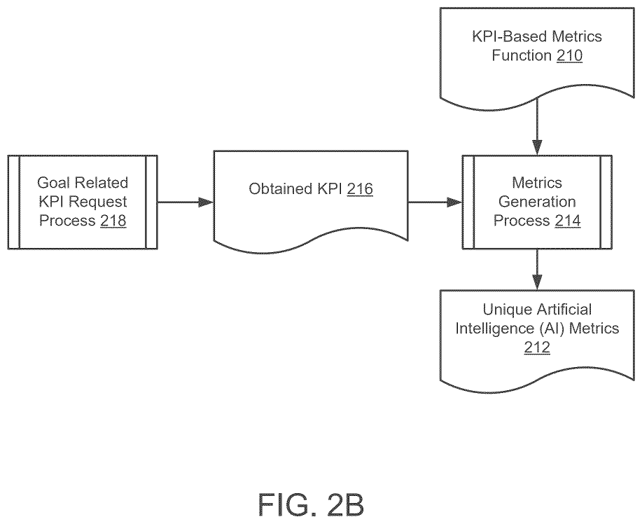

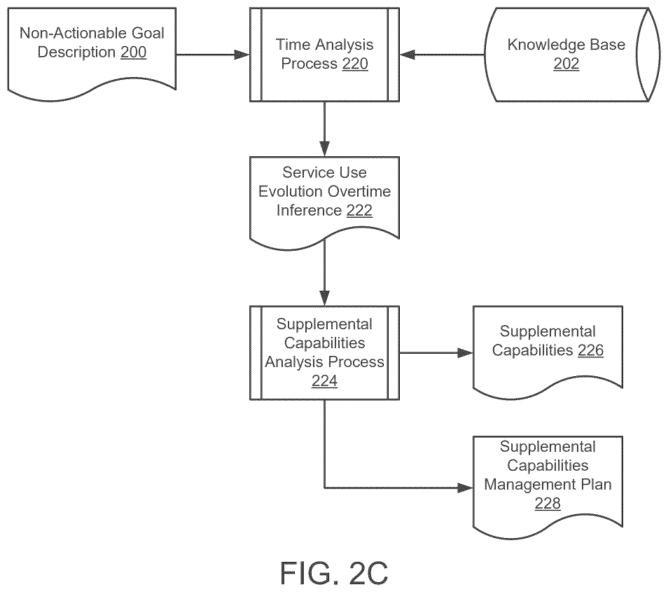

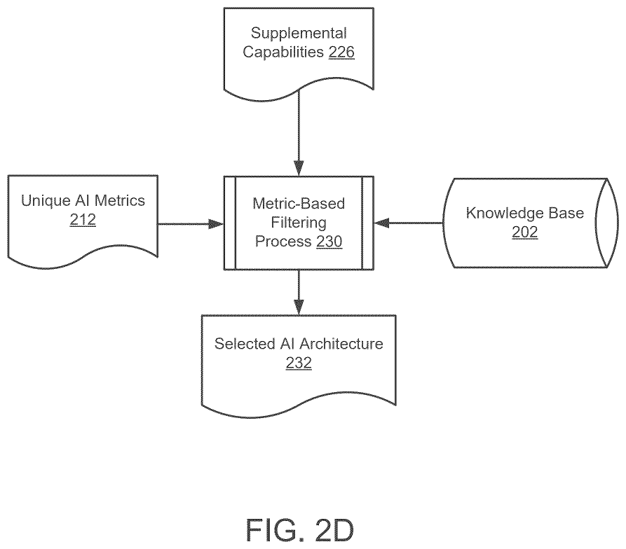

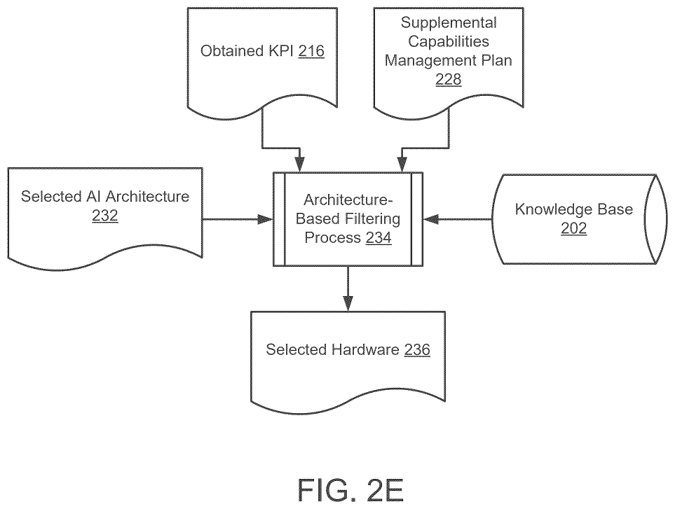

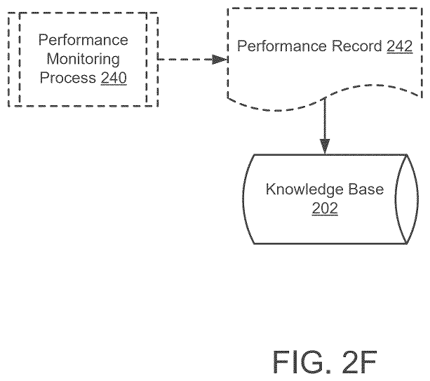

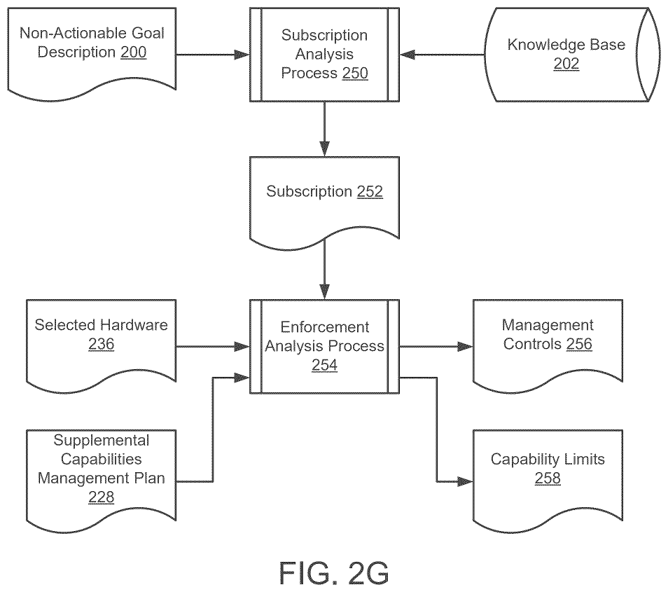

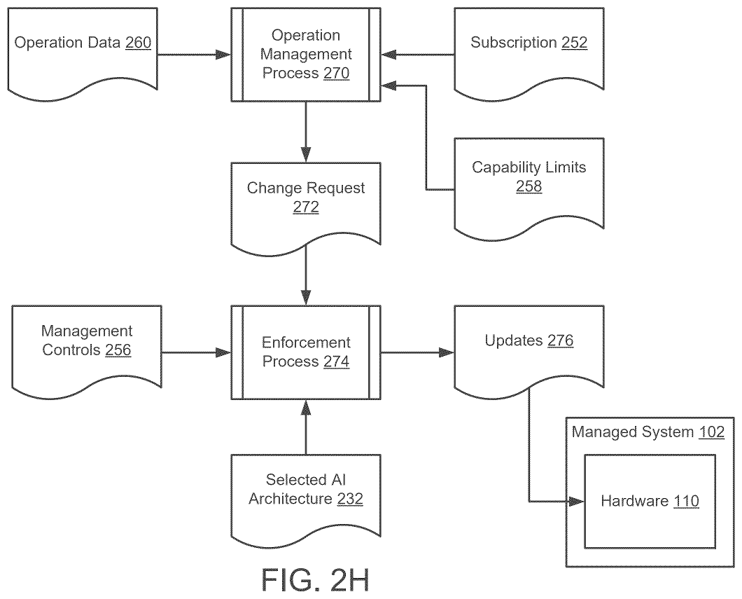

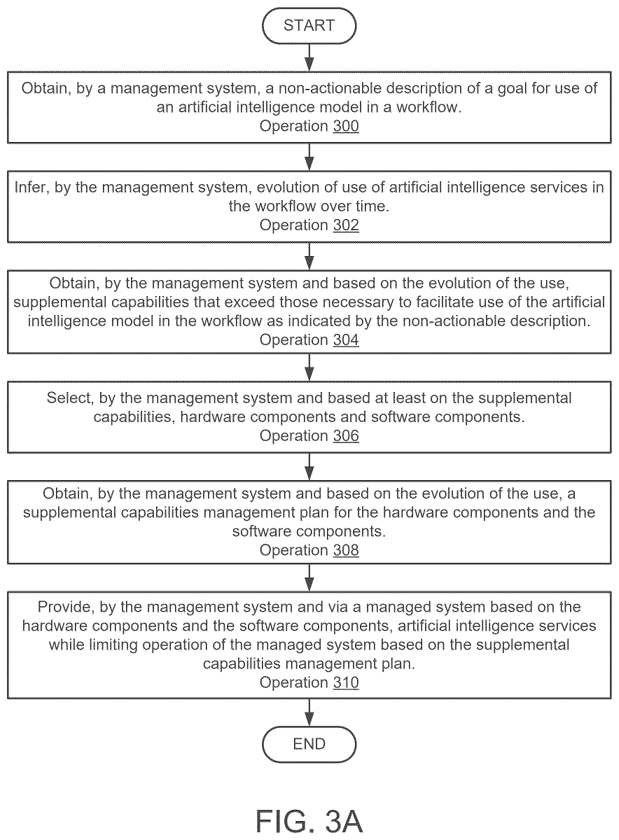

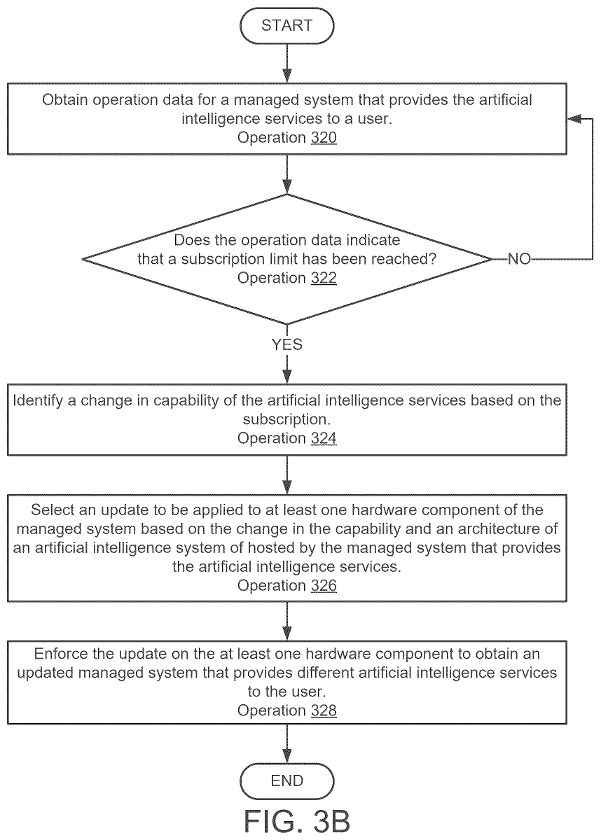

When providing their functionality, client devices 100, managed system 102, and/or management system 104 may perform all, or a portion, of the flows and/or methods shown in FIGS. 2A-3B.

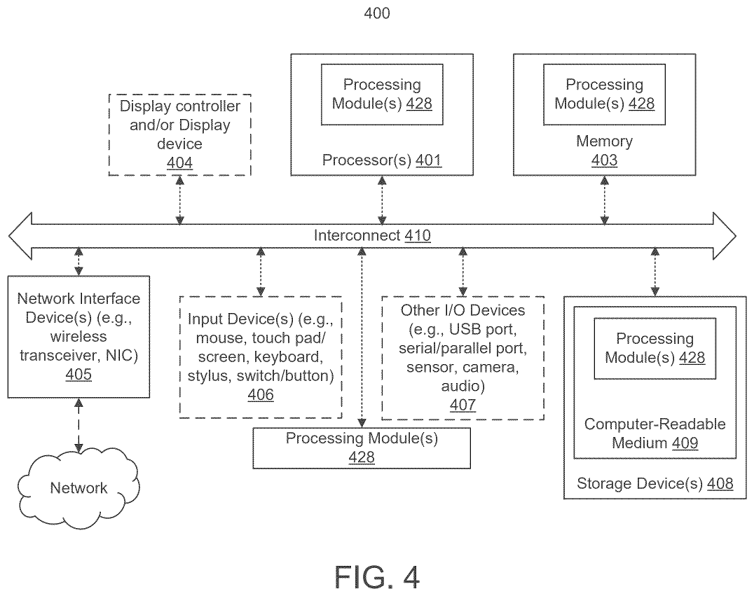

Any devices (and/or components thereof) included in the system of FIG. 1 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with a communication system (e.g., 106) utilized by client devices 100, managed system 102, and/or management system 104 to, for example, cooperate with one another to facilitate the architectural regulation framework.

In an embodiment, this communication system may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2H. These data flow diagrams may illustrate how data may be obtained and used within the system of FIG. 1.

In the data flow diagrams, such as in FIGS. 2A-2H, flows of data and processing of data are illustrated using different sets of shapes. In the context of these data flow diagrams, a first set of shapes (e.g., 200, 206, etc.) is used to represent data structures, a second set of shapes (e.g., 204, 208, etc.) is used to represent processes performed using and/or that generate data, and a third set of shapes (e.g., 202, etc.) is used to represent large scale data structures such as databases (e.g., that include some type of schema and/or a large repository of (e.g., proprietary) data).

Turning to FIG. 2A, a first data flow diagram in accordance with an embodiment is shown. The first data flow diagram may illustrate data used in and data processing performed in managing operation of a managed system to provide desired computer implemented services.

To provide the computer implemented services, for example, (i) a goal-based filtering process (e.g., 204) may be performed, and (ii) a functional relation generation process (e.g., 208) may be performed.

During goal-based filtering process 204, both (i) non-actionable goal description 200 and (ii) knowledge base 202 may be ingested. Once ingested, non-actionable goal description 200 and knowledge base 202 may be subjected to any number of data filtering processes. These data filtering processes may be based on, for example, non-actionable goal description 200.

For example, goal-based filtering process 204 may use a type of non-actionable goal description 200 as a key (or other discriminator to identify relevant information) to identify any type and quantity of corresponding data stored in knowledge base 202.

Knowledge base 202 may be implemented with a data repository, and therefore, may include any type and quantity information regarding any number of previously used artificial intelligence (AI) models (e.g., the proprietary information regarding the previously used AI models managed by management system 104) and correspondingly performed AI workloads (e.g., model training where training data is used to define model parameters, inferencing where a model ingests data and generates an output, model updating during which previously defined model parameters are updated based on new training data, etc.). Each of the AI models may be similar to and/or different from one another. For example, knowledge base 202 may include descriptions of AI models, parameters describing operation (e.g., accuracy, computational cost, etc.) of the AI models, etc.

To differentiate information regarding the AI models, knowledge base 202 may be organized as, for example, a table including rows, each respective row corresponding to one of the AI models or other type of structured data.

For example, each row may include information regarding a corresponding AI model and/or references to other data structures that include information regarding the corresponding AI model. Further, the rows may be keyed to facilitate efficient searches for data regarding properties of the corresponding AI model. These properties may include, for example, (i) a non-actionable goal description associated with the corresponding AI model, (ii) desired (e.g., by an associated client) key performance indicators (KPI) associated with the corresponding AI model, (iii) actual KPI achieved by the corresponding AI model based on performance of workflows using the corresponding AI model, (iv) metrics of the corresponding AI model defining the corresponding AI model's AI architecture, (v) the AI architecture (e.g., configurations and other AI architecture associated data) associated with the corresponding AI model, (vi) a supporting hardware system issued for the corresponding AI architecture, and/or (vii) any other properties of the corresponding AI model, not to be limited by embodiments discussed herein.

It will be appreciated that contents of knowledge base 202 may be leveraged any number of times throughout facilitation of the architectural regulation framework as discussed throughout, but not to be limited by, embodiments herein.

Non-actionable goal description 200 may be based on information obtained directly and/or indirectly from, for example, the client. For example, obtaining non-actionable goal description 200 may include (ii) distributing a first prompt regarding an existing approach used in a workflow and a desired change in the existing approach that is likely to improve a business goal for the workflow; and (ii) obtaining a first response to the first prompt. The first response may therefore include and/or indicate the information regarding non-actionable goal description 200 which may, in turn, be used (and/or already include) the type of non-actionable goal description 200.

Accordingly, the type of non-actionable goal description 200 may include the information regarding the existing approach used in the workflow and the desired change in the existing approach that is likely to improve the business goal for the workflow. For example, non-actionable goal description 200 may be implemented by (e.g., the first response may include) a string of data such as “using an AI model to sell more sticker decals on average by close of business each day than was previously sold on average by close of business each day during the week prior”.

This implementation may include identifying the type of non-actionable goal description 200 to be, for example, (i) a change to using an AI model for a business which did not previously depend on AI models, (ii) an increase in a volume of product sold by a business using the AI model, and/or (iii) any other desired change in the existing approach of the workflow that is likely to improve a business goal for the workflow. Alternatively, in some cases for example, the type may be implemented simply as an industry sector to which the AI model may contribute (e.g., an industry sector associated with sticker decal sales).

Therefore, during goal-based filtering process 204, various actions (e.g., data removal actions) that are based on non-actionable goal description 200 may be performed on knowledge base 202 to obtain discriminated portion of knowledge base 206. For example, discriminated portion of knowledge base 206 may be any number of the previously used AI models from knowledge base 202 that are likely to be relevant to one another based on the type of non-actionable goal description 200.

Discriminated portion of knowledge base 206 may, for example, then be ingested during functional relation generation process 208 to obtain key performance indicator (KPI)-based metrics function 210. For example, functional relation generation process 208 may include interpolation-based processing of data included in discriminated portion of knowledge base 206. The output of functional relation generation process 208 may indicate one or more relationships identified between one or more of the properties of the previously used AI models from the discriminated portion, the one or more relationships being, for example, consistent relative to the type of non-actionable goal description 200. Such relationships may be expressed using, for example, KPI-based metrics function 210.

It will be appreciated that the consistency of the one or more identified relationships may vary by a (e.g., negligible) degree of variance deemed acceptable on a case-by-case basis, requirements for the acceptability being determined by, for example, an authority associated with management system 104.

For example, KPI-based metrics function 210 may be implemented by an identifiable relationship between the actual KPIs of corresponding (and previously used) AI models and the metrics defining respective AI architectures of the corresponding AI models, the identifiable relationship being consistent (e.g., within the negligible degree of variance in the consistency) for each of the any number of AI models included in discriminated portion of knowledge base 206.

Therefore, should new KPI be desired by, for example, the client, metrics for a new AI model associated with non-actionable goal description 200 may be obtained based on the newly desired KPI and KPI-based metrics function 210.

For additional information regarding obtaining metrics based on new KPI (e.g., using KPI-based metrics function 210), refer to FIG. 2B, below.

Turning to FIG. 2B, a second data flow diagram in accordance with an embodiment is shown. The second data flow diagram may illustrate data used in and data processing performed in obtaining metrics for an AI model (e.g., the AI model that may be used in the workflow performed by managed system 102).

To do so, a metrics generation process (e.g., 214) may be performed. For example, during metrics generation process 214, (i) KPI-based metrics function 210 and (ii) obtained KPI 216 may both be ingested. Once ingested, obtained KPI 216 may be subjected to the previously identified relationship indicated by KPI-based metrics function 210 to obtain unique artificial intelligence (AI) metrics 212. Unique AI metrics 212 may include any number of AI model metrics that may each be associated with a performance rating that may range from low (e.g., less than adequate performance) to high (e.g., exceeding expected and/or desired performance).

These performance ratings may be implemented by, for example, (i) percentages, (ii) performance labels (e.g., “low” for low performance, “moderate” for performance that is near expectation, and “high” for meeting or exceeding expectation), (iii) rankings (e.g., each ranking being based on default/general AI model performance data from commonly used AI, based on the type of non-actionable goal description 200, etc.), and/or (iv) other schema for evaluating metrics, not to be limited by embodiments discussed herein.

Based on obtained KPI 216 and KPI-based metrics function 210, unique AI metrics 212 may be obtained and may include, for example, (i) high accuracy over time, (ii) low model complexity, (iii) moderate response time, (iv) moderate elasticity, (v) high load balancing, (vi) high model stability, (vii) moderate sensitivity, (viii) high resilience, (ix) high coherence, and/or (x) any other metrics used to quantify performance of the AI model.

In this example, a relationship between obtained KPI 216 and unique artificial intelligence (AI) metrics 212 may be the consistent identified relationship discussed previously. For example, obtained KPI 16 may include the new KPI desired by the client, mentioned above with regard to obtaining metrics based on new KPI in FIG. 2A.

Such desired KPI may include, for example, (i) an increasing sales growth, measured based on a week-by-week basis, (ii) an increase in the average purchase power of sticker decal buyers over time, (iii) a steady and/or increasing conversion rate regarding how many sale leads are converting to completed sticker decal sales, and/or (iv) any other quantifiable measurements for success of the AI model, not to be limited by embodiments discussed herein, and the success being relative to the type of non-actionable goal description 200.

To obtain the desired KPI, goal related KPI request process 218 may be performed. For example, goal related KPI request process 218 may include (ii) distributing a second prompt regarding quantifiable measurements for success of the desired change in the existing approach; and (ii) obtaining a second response to the second prompt. The second response may therefore include obtained KPI 216.

For additional information regarding how unique artificial intelligence (AI) metrics 212 may be used, refer to FIG. 2D discussed below.

Turning to FIG. 2C, a third data flow diagram in accordance with an embodiment is shown. The third data flow diagram may illustrate data used in and data processing performed in managing operation of a managed system to address future uses.

The flows shown in FIG. 2A-2B may be used to identify information usable to establish a managed system that is likely able to meet goals and/or other metrics indicated currently (e.g., temporally) by non-actionable goal description 200. However, due to rapid changes in use cases of AI workloads, the goals and/or uses cases may change over time. To proactively address future changes in goals and/or use cases, existing described uses of AI workloads may be projected into the future to identify likely future workloads, uses, etc. and use as a basis for managing the managed system.

To select how to manage the manage system based on likely future uses, time analysis process 220 may be performed. During time analysis process 220, non-actionable goal description 200 and knowledge base 202 may be used as a basis for identifying likely requirements, use, etc. regarding the services into the future. For example, the discriminated portion of the knowledge base (e.g., 206) and an estimation function (e.g., scaling function) may be used to infer how use of artificial intelligence services provided by the managed system are likely to change over time.

For example, the discriminated portion may include information regarding how managed system and artificial intelligence services provided by the managed systems have changed over time historically. The historic information may include changes in various AI workload rates. These changes in rates may be used to establish a scaling factor, which may be used to scale an existing expected use of the AI services as indicated by non-actionable goal description 200 over time. The resulting service use evolution over time inference 222 may indicate how use of services provided by the managed system are likely to scale over time.

In addition to scaling based on historic changes in workloads, if available, information regarding fundamental changes in workload types (e.g., such as due to changes in AI model architectures) may also be taken into account when establishing the scaling factor. The scaling factor thus may be used to project into the future linearly, may have some step function (e.g., if step changes in resource cost due to model changes have occurred in the past) characteristic, etc.

Once obtained, the inference may be used in supplemental capabilities analysis process 224 to establish (i) supplemental capabilities 226 to be available to a managed system, and (ii) supplemental capabilities management plan 228 for administrating (e.g., unlocking over time) supplemental capabilities 226. During supplemental capabilities analysis process 224, changes in service use evolution over time inference 222 may be used to identify extra capabilities (or capacities) for a managed system. The extra capabilities may be in addition to those that are required to provide desired services, as indicated by the non-actionable goal description and knowledge base derived information.

The supplemental capabilities (e.g., 226) may be selected on the basis of subject matter expert defined rules, historical information (e.g., resources necessary to provide various capabilities), and/or other basis. Thus, the resulting supplemental capabilities 226 may define capabilities to be available for provisioning by the managed system in addition to those indicated by non-actionable goal description 200.

The supplemental capabilities management plan (e.g., 228) may also be established on the basis of subject matter expert defined rules, the service use evolution overtime inference (e.g., 222, may be used to select when supplemental capabilities 226 are to be released for general use), and/or other basis. Thus, the resulting supplemental capabilities management plan 228 may define when supplemental capabilities 226 (and/or portions thereof) are to be made available (e.g., may otherwise may not be made available through software/hardware enforcement).

Turning to FIG. 2D, a fourth data flow diagram in accordance with an embodiment is shown. The fourth data flow diagram may illustrate data used in and data processing performed in selecting an AI architecture (e.g., 222) for an AI model (e.g., the AI model that may be used in the workflow performed by managed system 102).

To do so, a metrics-based filtering process (e.g., 230) may be performed. For example, during metrics-based filtering process 230, (i) unique artificial intelligence (AI) metrics 212, (ii) knowledge base 202, and supplemental capabilities 226 may be ingested. Once ingested, data included in knowledge base 202 may be subjected to any number of additional data filtering processes to identify AI architectures that meet or exceed the metrics included in unique artificial intelligence (AI) metrics 212 and provide the capabilities indicated by supplemental capabilities 226. Such AI architectures may include configurations for hardware and/or software components that determine types and/or a quantity of functionalities provided by the hardware and/or software components, and how they may be provided.

It will be appreciated that any quantity of AI architectures may be identified during metric-based filtering process 230 and that additional selection refining processes may be performed to select, for example, a single AI architecture (E.g., 232). Such additional selection refining processes may include selecting from the any quantity of the identified AI architectures based on, for example, cost placed on the client by particular AI architectures, obtained KPI 216, and/or other factors relevant to, for example the client's ability to utilize the AI model. Thus, selected AI architecture 232 may be obtained based on performance of metrics-based filtering process 230.

For additional information regarding how selected AI architecture 232 may be used, refer to FIG. 2E discussed below.

Turning to FIG. 2E, a fifth data flow diagram in accordance with an embodiment is shown. The fifth data flow diagram may illustrate data used in and data processing performed in selecting supportive hardware (e.g., 236) for an AI model (e.g., the AI model that may be used in the workflow performed by managed system 102).

To do so, an architecture-based filtering process (e.g., 234) may be performed. For example, during architecture-based filtering process 234, (i) selected AI architecture 232, (ii) obtained KPI 216, (iii) supplemental capabilities management plan 228, and (iv) knowledge base 202 may each be ingested.

Once ingested, data included in knowledge base 202 may be further subjected to any number of additional data filtering processes, similarly discussed above with regard to metric-based filtering process 230 in FIG. 2D, to select hardware for a hardware system capable of supporting selected AI architectures 232 while also meeting or exceeding obtained KPI 216 and having capabilities necessary to enforce supplemental capabilities management plane 228 (e.g., the selected hardware may need to be capable of being locked, connected in a particular manner, such as between graphics processing units and storage systems that contribute to the artificial intelligence services, etc.). Thus, selected hardware 236 may be obtained via performance of architecture-based filtering process 234.

Using selected hardware 236, selected AI architecture 232, obtained KPI 216, non-actionable goal description 200, and/or other information regarding expected performance of the AI model, managed system 102 may be created (e.g., constructed, programmed, configured, etc.) and otherwise made ready for deployment. Once deployed, managed system 102 may provide the computer implemented services as expected by the client by using the AI model to perform various workflows (e.g., inferencing, model training, etc.).

As part of deployment, various subscriptions may be established and used in management of management system 102. Refer to FIGS. 2G-2H for additional details regarding establishment and enforcement of subscriptions.

For additional information regarding performance of the workflow and/or additional information regarding knowledge base 202, refer to FIG. 2F discussed below.

Turning to FIG. 2F, a sixth data flow diagram in accordance with an embodiment is shown. The sixth data flow diagram may illustrate data used in and data processing performed in managing data stored in, for example, knowledge base 202.

For example, assume that the managed system performs the workflow using the AI model discussed above after managed system 102's deployment. Such workflow performance may be monitored over time (e.g., starting from the moment of successful deployment of the managed system and/or the providing of the computer implemented services).

To monitor the performance of the workflow, performance monitoring process 240 may be performed. For example, during performance monitoring process 240 a record may be populated with information regarding various properties of the AI model and how these various properties impact the AI model's success relative to, for example, the type of non-actionable goal description 200. Once populated with the information upon completion of performance monitoring process 240, performance record 242 may be obtained.

Based on this monitoring, performance record 242 may therefore include various corresponding properties of the AI model. These corresponding properties may include, for example, (i) the non-actionable goal description for the AI model, (ii) the desired KPI (e.g., obtained KPI 216), (iii) actually met or exceeded KPI, (iv) metrics of the AI model (e.g., unique AI metrics 212), (v) the AI architecture of the AI model (e.g., selected AI architecture 232), (vi) a hardware system supporting the AI model (e.g., selected hardware 236), and/or (vii) any other data regarding properties of the AI model not to be limited by embodiments discussed herein.

Once performance record 242 is obtained, knowledge base 202 may be updated to include performance record 242 (e.g., the data from performance record 242). In doing so, future facilitation of the architectural regulation framework may include accessibility to (and therefore, consideration of) how the AI model performed, the AI model having become one of the previously used AI models from knowledge base 202 upon completion of the update of knowledge base 202.

It will be appreciated that in FIG. 2F, performance monitoring process 240 and performance record 242 are illustrated with dashed borders. These dashed borders are included to discuss how this process (e.g., 240) and this data structure (e.g., 242) may each be performed and/or obtained, respectively, any number of times.

For example, instead of data associated with the AI model discussed throughout FIGS. 1-2H, each of the any number of times may regard a different performance of a different AI model used in a workflow performed by a same or different managed system post deployment of the same or different managed system (e.g., all the managed systems being managed by management system 104).

Therefore, each performance record may be populated by data associated with a different AI model's performance, each performance record being subsequently used to update knowledge base 202. Knowledge base 202 may thereby by managed to include up-to-date information regarding the previously used AI models.

Turning to FIG. 2G, a seventh data flow diagram in accordance with an embodiment is shown. The seventh data flow diagram may illustrate data used in and data processing performed in establishment of subscriptions and enforcement mechanisms for managed systems.

To establish subscriptions, subscription analysis process 250 may be performed. During subscription analysis process 250, non-actionable goal description 200 may be analyzed in view of the relevant information from knowledge base 202 to establish subscription 252. To establish subscription 252, the relevant information based on non-actionable goal description 200 may be used to define (i) expected performance for services provided by managed systems, and (ii) limits on use of the services. The limits on use of the services may be negotiated (e.g., which the entity that is to receive services from managed system 102) and may be based on any metric (e.g., number of inferences/trainings/updates to models, rates of inferencing/training/updating models, etc.). Once identified, subscription 252 may memorialize the expected rates, limits, and/or other aspects of services to be provided by a managed system.

Once subscription 252 is obtained, enforcement analysis process 254 may be performed to obtain (i) management controls 256 and (ii) capability limits 258. Management controls 256 may be capabilities of hardware/software of managed system 102 usable to limit use of services provided by managed system 102. Capability limits 258 may be the limits to be enforced on managed system 102 over time.

During enforcement analysis process 254, selected hardware 236 may be analyzed to identify control mechanisms usable to limit different types of workloads that may be performed by managed system 102. The control mechanisms may include, for example, (i) limiting communication bandwidth between hardware components (e.g., graphics processing units, storage devices, etc.) of managed system 102 which may reduce rates of services that can be provided, (ii) locking cores of hardware components of managed system 102 which may reduce rates of services that can be provided, (iii) changes in configurations that may be applied to hardware/software components of managed system 102 (e.g., resetting back to a default configuration that is not optimized for AI workloads) which may reduce rates of services that can be provided, etc. These mechanisms may be stored as part of management controls 256, and may be linked to subscription 252 so that when limits of subscription 252 are reached, corresponding controls maybe automatically employed to reduce rates of services provided by managed system 102.

Also, during enforcement analysis process 254, supplemental capabilities management plan 228 may be analyzed based on selected hardware 236 to establish additional capability limits 258 to be enforced over time. The capability limits (e.g., 258) may specify when and how management controls 256 are to be used to limit use of the supplemental capabilities that managed system 102 may provide.

For example, capability limits 258 may indicate various management controls 256 that are to be set over time to limit use of the services. In an example, one of management controls 256 may be used to initially reduce bandwidth between a graphics processing unit and a storage system so that the graphics processing unit is unable to be used in artificial intelligence workloads performed by managed system 102. Capability limits 258 may indicate the level of reduction in bandwidth, and changes over time (e.g., the bandwidth may be increased over time so that use of the graphics processing unit become available at a future point in time).

Once obtained, subscription 252, management controls 256, and capability limits 258 may be used to program operation of managed system 102. The resulting managed system 102 may include various limits (e.g., reduce communication bandwidth, locked processing cores, etc.) of use of hardware components, host reporting frameworks for identifying use services provided by the managed system, and host enforcement frameworks for enforcing subscription limits based on the monitored use of the services provided by the managed system. Refer to FIG. 2H for additional information regarding management of operation of managed system 102 based on the subscriptions, management controls, and capability limits.

Turning to FIG. 2H, an eighth data flow diagram in accordance with an embodiment is shown. The eighth data flow diagram may illustrate data used in and data processing performed in management of operation of a managed system.

To manage the operation of a managed system, operation management process 270 may be performed. During subscription enforcement process 274, operation data 260 may be evaluated based on subscription 252 and capability limits 258.

Operation data 260 may include any quantity and type of information regarding operation of managed system 102. The information may include information usable to quantify use of services provided by managed system 102. The use may be compared to subscription 252 to identify whether any limits have been reached. If a limit has been reached based on the use (e.g., number/rates of use, duration of use, etc.), then an enforcement action may be initiated. To do so, information regarding the limit that is hit and corresponding control usable to enforce the limits may be added to change request 272.

Additionally, the use (e.g., such as duration of use) may be compared to capability limits 258. As discussed above, capability limits 258 may indicate capabilities of managed system 102 that may initially be limited but then may be unlocked over time. The duration of use may be compared to capability limits 258 to identify whether any capabilities are to be unlocked (or locked, capabilities could be locked over time). If any are to be changed, information regarding the change in capabilities may also be added to change request 272.

Once change request 272 is obtained, enforcement process 274 may be performed. During enforcement process 274, any number of updates (e.g., 276) to operation of managed system 102 may be identified and made to hardware 110 of managed system 102.

Any of the changes specified by change request 272 may reference management controls 256 (and/or portions of selected AI architecture 232). The referencing may enable enforcement process 274 to identify how to make changes to the operation of managed system 102.

For example, if change request 272 indicates a change to an inferencing capability of managed system 102, a corresponding management control from management controls 256 may be identified. In this example, the management control may be a change in communication bandwidth between a graphics processing unit and a storage devices. These two hardware components may contribute to inferencing workloads and bandwidth of a communication bus (e.g., may be a link in a network, a point to point connection, a bus connecting multiple hardware components, etc.) between these hardware components may restrict the rate at which artificial intelligence workloads can be provided by managed system 102. If change request 272 indicates that the inferencing rate is to be decreased due to a subscription limit being reached, then the identified management control may be used to reduce the inferencing rate by sending an update to hardware 110 that restricts the communication bandwidth. In contrast, if change indicates that the inferencing rate is to be increased, then an update may be sent to hardware 210 to increase the communication bandwidth. The decree of restriction may be based on the corresponding subscription limit or change in capability limits.

Once updates 276 are obtained, an automation framework hosted by managed system 102 may receive, process, and modify operation of hardware 110 based on the update. In this manner, the operation of managed system 102 may be updated overtime based on subscription limits and capability limits.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage the operation of managed systems to provide desired computer implemented services. FIGS. 3A-3B illustrates methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method for managing operation of a managed system in accordance with an embodiment is shown. The method may be performed by any of the components of the system of FIG. 1.

At operation 300, a non-actionable description of a goal is obtained for use of an artificial intelligence (AI) model in a workflow performed by a managed system. The non-actionable goal description may be obtained by (i) distributing (e.g., by management system 104) a prompt to a user, and (ii) obtaining (e.g., by the management system) a response to the prompt.

At operation 302, evolution of use of the artificial intelligence services in the workflow overtime is inferred by the management system. The evolution may be inferred using an inference model, historical data regarding uses of other artificial intelligence services may various users, and/or via other methods. The resulting inference may project changes in the use of the artificial intelligence services over time into the future.

At operation 304, supplemental capabilities that exceed those necessary to facilitate use of an artificial intelligence model in the workflow as indicated by the non-actionable description are obtained based on the evolution of the use. The supplemental capabilities may be obtained, for example, by applying a set of rules or other system for converting the projected change in use indicated by the evolution of the use over time to capabilities (e.g., available computing resources) for meeting the project change in use. For example, increased inference rates projected into the future, changes in model size and capability, and/or other types of inferred changes may be used to estimate additional resources that may need to be available to meet the changes in use in the future.

At operation 306, hardware components and software components are selected based at least on the supplemental capabilities. The hardware components and software components may be for a managed system to provide the services. The hardware components and software components may be selected using a knowledge base usable to identify hardware that can provide the computing resources indicated by the supplemental capabilities and/or software components for use with the hardware components to support future instances of the workflow. For example, the knowledge base may include examples of previously implemented managed systems, and a system having similar requirements may be identified. The hardware/software components of the similar system may be used to select the hardware/software components.

At operation 308, a supplemental capabilities management plan for the hardware components and the software components is obtained based on the evolution of the use. The supplemental capabilities management plan may be obtained by populating a template with information from the evolution of the use and the hardware components and the software components. For example, the template may be schedule, and the evolution of the use may be used to set dates in the schedule. Initially, the schedule may specify restrictions to limit use of the supplemental capabilities. The schedule may lift the restrictions over time in accordance with the evolution of the use (e.g., the restrictions on the supplemental capabilities may be lifted following the inferred use).

The supplemental capabilities management plan may include any number of restrictions including, for example, derating of a hardware component from a nominal clock speed to a reduced clock speed; depowering of a processing core of the hardware component; and restricting workload types performable by the processing core. The workload types may include any of inference model training; inferencing; and inference model updating.

At operation 310, artificial intelligence services are provided while limiting operation of the managed system based on the supplemental capabilities management plan. The artificial intelligence services may be provided by a managed system that is based on the hardware components and the software components. For example, a managed system may be built and deployed based on the hardware components and the software components.

While operating, the managed system may be managed by a management system. The artificial intelligence services may be limited based on, for example, limitations on operation imposed on the managed system based on the supplemental capabilities management plan. As time progresses, the limitations may be relaxed as specified by the supplemental capabilities management plan. For example, various communication systems, hardware components, etc. may be reconfigured over time based on the supplemental capabilities management plan.

The method may end following operation 310.

Thus, using the method illustrated in FIG. 3A, the services provided by a managed system may be modified overtime to be more likely to meet the desired goals of users of the managed system.

Turning to FIG. 3B, a second flow diagram illustrating a method for managing operation of a managed system in accordance with an embodiment is shown. The method may be performed by any of the components of the system of FIG. 1.

At operation 320, operation data for a managed system that provides artificial intelligence services to a user is obtained. The operation data may be obtained by reading it from storage, receiving it from another devices, generating it, and/or via other methods. The operation data may be generated by monitoring operation of the managed system over time. The operation data may indicate, for example, rates and/or numbers of uses of the artificial intelligence services, duration of use, etc.

At operation 322, a determination is made regarding whether the operation data indicates that a subscription limit has been reached. The determination may be made by comparing the operation data to the subscription limit (e.g., which may specify a number, rate, duration, and/or other type of limit on use of the artificial intelligence services).

For example, a subscription may define a time limit for one of a plurality of artificial intelligence workload types; and a rate for the one of the plurality of artificial intelligence workload types. If the operation data indicates that any have been met, then the subscription limit may have been reached.

If the subscription limit has been reached, then the method may proceed to operation 324. Otherwise the method may return to operation 320.

At operation 324, a change in capability of the artificial intelligence services may be identified based on the subscription. The subscription may specify or indirectly indicate the change in the capability. The change in the capability may be, for example, to reduce a prescribed rate from that indicated by the subscription to a reduced or lower rate.

At operation 326, an update to be applied to at least one hardware component of the managed system is selected based on the change in the capability and an architecture of an artificial intelligence system hosted by the managed system that provides the artificial intelligence services. The update may be selected based on the artificial intelligence architecture by (i) identifying control mechanisms, (ii) identifying how to use the control mechanism to effectuate the reduction identified in operation 324, and (iii) generating an update based on the control mechanism.

For example, the architecture of the artificial intelligence system may include various hardware components interconnected via communication links. Reduction in communication link bandwidth may reduce the rate at which these components may contribute to the artificial intelligence services. Similarly, the hardware components may include processing cores which may be selectively locked to not contribute to the artificial intelligence services. Further, the hardware components and software components may include various configurations that are optimized for provisioning of the services, and if reset (e.g., reconfigured) to defaults (e.g., a default state) then the rate at which the artificial intelligence services may be provided may be reduced. The updates may include instructions for modifying any of these to effectuate the reduced rate of provisioning of the artificial intelligence services identified in operation 324.

For example, to select the update, a dependency of an artificial intelligence workload type on a communication bus may be identified using the architecture; and a new communication bandwidth for the communication bus may be selected to reduce the rate at which the artificial intelligence services are able to be provided. The artificial intelligence workload type may be any of inference model training having a first level of dependency on the communication bandwidth; inferencing having a second level of dependency on the communication bandwidth; and inference model updating having a third level of dependency on the communication bandwidth.

At operation 328, the update is enforced on the at least one hardware component to obtain an updated managed system that provides different artificial intelligence services to the user. The update may be enforced by modifying operation of the at least one hardware components based on the update. For example, an enforcement framework hosted by the managed system may automatically take action to perform the update once received.

The method may end following operation 328.

Thus, using the method shown in FIG. 3B, embodiments disclosed herein may facilitate subscription based management of artificial intelligence services in a manner that may limit but not prevent use of artificial intelligence services.

Any of the components illustrated in FIGS. 1-2H may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing artificial intelligence services, the method comprising:
obtaining, by a management system, a non-actionable description of a goal for use of an artificial intelligence model in a workflow;
inferring, by the management system, evolution of use of artificial intelligence services in the workflow over time;
obtaining, by the management system and based on the evolution of the use, supplemental capabilities that exceed those necessary to facilitate use of the artificial intelligence model in the workflow as indicated by the non-actionable description;
selecting, by the management system and based at least on the supplemental capabilities, hardware components and software components;
obtaining, by the management system and based on the evolution of the use, a supplemental capabilities management plan for the hardware components and the software components; and
providing, by the management system and via a managed system based on the hardware components and the software components, artificial intelligence services while limiting operation of the managed system based on the supplemental capabilities management plan.

2. The method of claim 1, wherein the supplemental capabilities management plan defines limits on use of the hardware components and/or the software components over time.

3. The method of claim 2, wherein the supplemental capabilities management plan relaxes the limits of the use over time, and changes in the limits defined by the supplemental capabilities management plan are based on the evolution of the use of the artificial intelligence services in the workflow.

4. The method of claim 1, further comprising:
obtaining the managed system; and
deploying the managed system,
wherein the deploying is performed prior to the providing of the artificial intelligence services.

5. The method of claim 1, wherein the supplemental capabilities management plan defines at least one selected from a group of limits consisting of:
derating of a hardware components of the hardware components from a nominal clock speed to a reduced clock speed;
depowering of a processing core of the hardware component; and
restricting workload types performable by the processing core.

6. The method of claim 5, wherein the workload types comprises at least selected from a list of workloads consisting of:
inference model training;
inferencing; and
inference model updating.

7. The method of claim 5, wherein the managed system is adapted to enforce the restricting of the workload types performable by the processing core by limiting communication capabilities of the processing core.

8. The method of claim 7, wherein the processing cores is operably connected to a storage device via a communication bus, and bandwidth of the communication bus is set by the managed system to enforce the restrictions of the workload types.

9. The method of claim 7, wherein the processing core is a core of a hardware accelerator.

10. The method of claim 1, wherein the managed system comprises at least one graphic processing unit that is in operable communication with a storage system via a communication bus.

11. A non-transitory machine-readable medium having instructions stored therein, which when executed by a processor, cause operations for providing artificial intelligence services to be performed, the operations comprising:
obtaining, by a management system, a non-actionable description of a goal for use of an artificial intelligence model in a workflow;
inferring, by the management system, evolution of use of artificial intelligence services in the workflow over time;
obtaining, by the management system and based on the evolution of the use, supplemental capabilities that exceed those necessary to facilitate use of the artificial intelligence model in the workflow as indicated by the non-actionable description;
selecting, by the management system and based at least on the supplemental capabilities, hardware components and software components;
obtaining, by the management system and based on the evolution of the use, a supplemental capabilities management plan for the hardware components and the software components; and
providing, by the management system and via a managed system based on the hardware components and the software components, artificial intelligence services while limiting operation of the managed system based on the supplemental capabilities management plan.

12. The non-transitory machine-readable medium of claim 11, wherein the supplemental capabilities management plan defines limits on use of the hardware components and/or the software components over time.

13. The non-transitory machine-readable medium of claim 12, wherein the supplemental capabilities management plan relaxes the limits of the use over time, and changes in the limits defined by the supplemental capabilities management plan are based on the evolution of the use of the artificial intelligence services in the workflow.

14. The non-transitory machine-readable medium of claim 11, wherein the operations further comprise:
obtaining the managed system; and
deploying the management system,
wherein the deploying is performed prior to the providing of the artificial intelligence services.

15. The non-transitory machine-readable medium of claim 11, wherein the supplemental capabilities management plan defines at least one selected from a group of limits consisting of:
derating of a hardware components of the hardware components from a nominal clock speed to a reduced clock speed;
depowering of a processing core of the hardware component; and
restricting workload types performable by the processing core.

16. A data processing system, comprising:
a processor; and
a memory coupled to the processor to store instructions, which when executed by the processor, cause operations for providing artificial intelligence services to be performed, the operations comprising:
obtaining, by a management system, a non-actionable description of a goal for use of an artificial intelligence model in a workflow;
inferring, by the management system, evolution of use of artificial intelligence services in the workflow over time;
obtaining, by the management system and based on the evolution of the use, supplemental capabilities that exceed those necessary to facilitate use of the artificial intelligence model in the workflow as indicated by the non-actionable description;
selecting, by the management system and based at least on the supplemental capabilities, hardware components and software components;
obtaining, by the management system and based on the evolution of the use, a supplemental capabilities management plan for the hardware components and the software components; and
providing, by the management system and via a managed system based on the hardware components and the software components, artificial intelligence services while limiting operation of the managed system based on the supplemental capabilities management plan.

17. The data processing system of claim 16, wherein the supplemental capabilities management plan defines limits on use of the hardware components and/or the software components over time.

18. The data processing system of claim 17, wherein the supplemental capabilities management plan relaxes the limits of the use over time, and changes in the limits defined by the supplemental capabilities management plan are based on the evolution of the use of the artificial intelligence services in the workflow.

19. The data processing system of claim 16, wherein the operations further comprise:
obtaining the managed system; and
deploying the management system,
wherein the deploying is performed prior to the providing of the artificial intelligence services.

20. The data processing system of claim 16, wherein the supplemental capabilities management plan defines at least one selected from a group of limits consisting of:
derating of a hardware components of the hardware components from a nominal clock speed to a reduced clock speed;
depowering of a processing core of the hardware component; and
restricting workload types performable by the processing core.
